(19) United States
(12) Patent Application Publication
(10) Pub. No.: US 2022/0123473 A1
(43) Pub. Date: Apr. 21, 2022

(54) SHORTED-STUB ANTENNA

(71) Applicant: QUALCOMM Incorporated, San Diego, CA (US)

(72) Inventor: Assaf AVIV, Carlsbad (CA)

(21) Appl. No.: 17/074,071

(22) Filed: Oct. 19, 2020

(51) Int. Cl. H01Q 9/04; H01Q 21/06; H01Q 9/06; H01Q 9/42

(52) U.S. Cl. CPC H01Q 9/0421; H01Q 9/42; H01Q 9/065; H01Q 21/061

(57) ABSTRACT

An antenna system includes: a ground plane conductor; a substrate; and an array including subarrays each configured to receive energy of a radiating frequency at an input and including: a microstrip signal line electrically coupled to the input and disposed such that the substrate is disposed between the microstrip signal line and the ground plane conductor; microstrip stubs extending from the microstrip signal line and disposed such that the substrate is disposed between the microstrip stubs and the ground plane conductor; and electrically-conductive connectors each connected to a respective one of the microstrip stubs about one-quarter of a wavelength, at the radiating frequency in the substrate, from the microstrip signal line along a length of the respective one of the microstrip stubs and electrically connecting the respective one of the microstrip stubs to the ground plane conductor.

### BACKGROUND

Wireless signals may be used for numerous applications. For example, with the proliferation of mobile communication devices, wireless signals of many frequencies and protocols have been, and/or are currently being, used for wireless communications, e.g., cellular communications, WiFi communications, etc. As another example, applications for distance detection have become popular, e.g., for sporting activities such as golf, and for driving assistance such as to help maintain a safe distance between moving vehicles or to warn of the approach of an object. As another example, applications for object detection have become more popular. Object detection may be useful for a variety of reasons/applications such as detecting the presence of a living object in a vicinity of a wireless charging system to help avoid harming the living object, collision avoidance for autonomous vehicle driving systems, etc.

To facilitate and/or enable wireless signal applications, numerous types of antennas have been developed, with different antennas used based on the needs of an application, e.g., distance, frequency, operational frequency bandwidth, antenna pattern beamwidth, gain, beam steering, etc.

### SUMMARY

An example antenna system includes: a ground plane conductor; a substrate disposed in contact with the ground plane conductor; and an array including a plurality of subarrays each configured to receive energy of a radiating frequency at an input of the subarray and each including: a microstrip signal line electrically coupled to the input and disposed in contact with the substrate such that the substrate is disposed between the microstrip signal line and the ground plane conductor; a plurality of microstrip stubs extending from the microstrip signal line and disposed in contact with the substrate such that the substrate is disposed between the plurality of microstrip stubs and the ground plane conductor; and a plurality of electrically-conductive connectors each connected to a respective one of the plurality of microstrip stubs about one-quarter of a wavelength, at the radiating frequency in the substrate, from the microstrip signal line along a length of the respective one of the plurality of microstrip stubs and electrically connecting the respective one of the plurality of microstrip stubs to the ground plane conductor.

Implementations of such a system may include one or more of the following features. The microstrip signal lines of adjacent pairs of the plurality of subarrays have centerlines disposed substantially parallel to each other and separated by about one-half of a free-space wavelength at the radiating frequency. Each of the plurality of electrically-conductive connectors includes at least one conductive via extending from a respective one of the plurality of microstrip stubs through the substrate to the ground plane conductor. The antenna system includes: front-end circuitry electrically coupled to the input of each of the plurality of subarrays and configured to provide signals to the plurality of subarrays; and a controller communicatively coupled to the front-end circuitry and configured to cause the front-end circuitry to provide different phases of the signals to different ones of the plurality of subarrays to steer a beam produced by the array in response to the signals provided by the front-end circuitry. The array is a transmit array, and the antenna system includes a receive array configured to receive reflected signals including reflections of signals transmitted by the transmit array, the receive array being communicatively coupled to the front-end circuitry and configured to provide the reflected signals to the front-end circuitry.

Also or alternatively, implementations of such a system may include one or more of the following features. For each of the plurality of subarrays, at least some of the plurality of microstrip stubs extend from the microstrip signal line on alternating sides of a centerline of the microstrip signal line. The at least some of the plurality of microstrip stubs have center-to-center spacings of about one-half of the wavelength at the radiating frequency in the substrate. Each stub of adjacent subarrays disposed a similar distance from an end of the respective microstrip signal line extends away from the respective microstrip signal line in a similar direction.

Also or alternatively, implementations of such a system may include one or more of the following features. Each of the plurality of microstrip stubs extends from the microstrip signal line at an angle between 80° and 100° relative to a longitudinal axis of the microstrip signal line. Different ones of the plurality of microstrip stubs have different widths.

An example method of operating an antenna system includes: receiving radio-frequency signals at an antenna array including a plurality of subarrays, the radio-frequency signals having a frequency; conveying the radio-frequency signals along a respective microstrip signal line of each of the plurality of subarrays; conveying the radio-frequency signals from the respective microstrip signal lines into respective microstrip stubs that extend from the respective microstrip signal lines and are shorted to ground about a quarter of a wavelength, from the respective microstrip signal lines along lengths of the respective microstrip stubs, at the frequency in a substrate on which the microstrip signal lines and the microstrip stubs are disposed; and radiating the radio-frequency signals from the microstrip stubs.

Implementations of such a method may include one or more of the following features. The method includes sending the radio-frequency signals to the antenna array, with the microstrip signal lines being disposed parallel to each other with adjacent ones of the microstrip signal lines having respective centerlines separated by about one half of a free-space wavelength at the frequency, to steer a beam provided by radiating the radio-frequency signals from the microstrip stubs.

Another example antenna system includes: one or more subarrays each including a plurality of transducer stubs; means for delivering radio-frequency signals to the plurality of transducer stubs along a length of a respective portion of the means for delivering in each of the plurality of subarrays; and means for shorting each of the plurality of transducer stubs, to a ground of the antenna system, about one-quarter of a wavelength of a frequency of the radio-frequency signals along a length of each of the plurality of transducer stubs.

Implementations of such a system may include one or more of the following features. The respective portions of the means for delivering are arranged in the array with a center-to-center spacing of about one-half of a free-space wavelength of the frequency of the radio-frequency signals. The antenna system includes controlling means for providing the radio-frequency signals to the means for delivering to steer a beam produced by the plurality of transducer stubs. Each of the one or more subarrays includes at least six transducer stubs. The one or more subarrays includes a plurality of subarrays disposed in an apparatus such that conductive lines of the means for delivering are spaced apart in an azimuthal plane of the apparatus. Each of the conductive lines of the means for delivering is angled with respect to an elevation axis of the apparatus by approximately twelve degrees or less. The apparatus includes a car. The antenna system includes a portion of a base station configured to communicate using millimeter-wave signals.

### BRIEF DESCRIPTION OF THE DRAWINGS

FIG. 1 is a simplified view of an environment that includes devices that may transmit and/or receive wireless signals.

FIG. 2 is a simplified block diagram of an antenna system included in a device shown in FIG. 1.

FIG. 3 is a perspective view of an example of an antenna shown in FIG. 2.

FIG. 4 is a top view of the example antenna shown in FIG. 3.

FIG. 5 is a block flow diagram of a method of operating an antenna system.

FIG. 6 is a front view of an example use of an antenna system as part of an autonomous vehicle-driving system.

FIG. 7 is a simplified cross-sectional side view of the antenna system in a vehicle shown in FIG. 6.

FIG. 8 are plots of co-polarization and cross-polarization azimuth and elevation return loss for a simulated example of an antenna subarray similar to subarrays shown in FIGS. 3-4.

### DETAILED DESCRIPTION

Antenna configurations are discussed herein, as are techniques for providing a steerable antenna pattern. For example, a comb-line antenna system includes multiple comb-line antenna sub-arrays. Each sub-array may include a microstrip line with stubs extending away from the microstrip line. Each stub may extend about a quarter of a wavelength away from the microstrip line to an electrical short to a ground plane. The sub-arrays may be disposed such that the respective microstrip lines are parallel to each other and have a center-to-center spacing of about one-half of the wavelength. The combination of the sub-arrays may be used to produce a beam and steer the beam in a direction of the spacing of the sub-arrays (e.g., transverse to the microstrip lines). Other configurations, however, may be used.

Antennas discussed herein may be used for a variety of purposes. For example, antennas discussed herein may be used for wireless communication, e.g., millimeter-wave, broadband, high-speed wireless communication. As further examples, antennas discussed herein may be used for object detection (e.g., in automotive systems), distance determination, etc.

Items and/or techniques described herein may provide one or more of the following capabilities, as well as other capabilities not mentioned. An antenna beam may be provided from a low-profile antenna and the antenna beam steered over a significant sweep angle while maintaining a good antenna pattern, e.g., without grating lobes. A low-profile antenna may be provided with multiple sub-arrays, each with a microstrip line and multiple stubs transverse to, and extending from, the microstrip line, and each with a beamwidth of about 90° in a direction transverse to the microstrip line. Other capabilities may be provided and not every implementation according to the disclosure must provide any, let alone all, of the capabilities discussed.

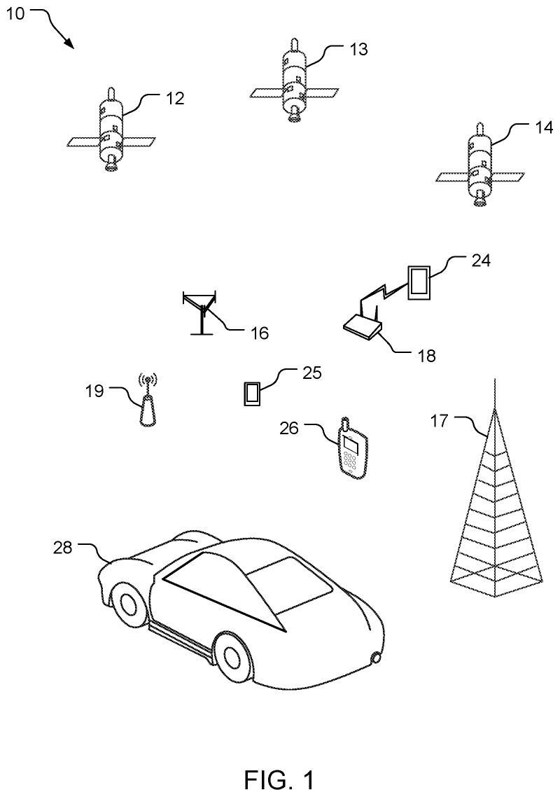

Referring to FIG. 1, an environment 10 includes devices that may transmit and/or receive wireless signals for various purposes. The devices shown in FIG. 1 are not exhaustive, and many other devices may use wireless signals and techniques discussed herein may be applicable not only to one or more devices shown in FIG. 1, but to one or more of such other devices. The environment 10 includes satellites 12, 13, 14, base stations 16, 17, 18, 19, mobile devices 24, 25, 26, and a vehicle 28. Wireless signals with various properties may be used in the environment 10. For example, signals of different frequencies, protocols, signal strengths, encryption mechanisms, etc. may be used in the environment 10.

The base stations 16-19 may each be configured to use (e.g., transmit and/or receive) one or more types of wireless signals in accordance with one or more radio access technologies (RATs). For example, the base stations 16-19 may be configured to use wireless signals for one or more RATs including GSM (Global System for Mobile Communications), code division multiple access (CDMA), wideband CDMA (WCDMA), Time Division CDMA (TD-CDMA), Time Division Synchronous CDMA (TDS-CDMA), CDMA2000, High Rate Packet Data (HRPD), LTE (Long Term Evolution), and/or 5G NR (5G New Radio). Each of the base stations 16, 17 may be a wireless base transceiver station (BTS), a Node B, an evolved NodeB (eNB), a 5G NodeB (SGNB), etc., and each of the base stations 18, 19 may be referred to as an access point and may be a femtocell, a Home Base Station, a small cell base station, a Home Node B (HNB), a Home eNodeB (HeNB), etc.

The mobile devices 24-26 may be configured in a variety of ways to use one or more of a variety of wireless signals. For example, each of the mobile devices 24-26 may be configured to use one or more of the RATs discussed above with respect to the base stations 16-19. The mobile devices 24-26 may be any of a variety of types of devices such as a smartphone, a tablet computer, a notebook computer, a laptop computer, etc. Each of the mobile devices 24-26 may be a User Equipment (UE), a 5G User Equipment (5G UE), a mobile station (MS), a subscriber unit, a target, a station, a device, a wireless device, a terminal, etc.

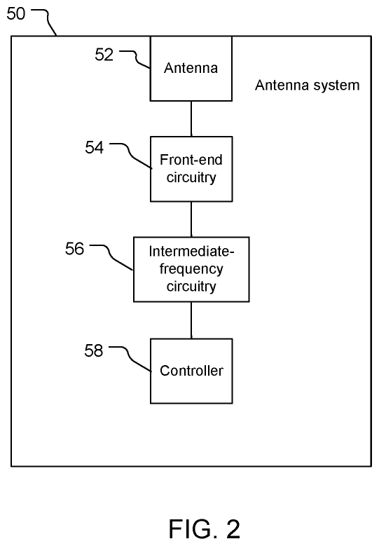

Referring also to FIG. 2, each of the devices in the environment 10 may include one or more antenna systems 50 for transmitting and/or receiving wireless signals. The antenna system 50 includes an antenna 52, front-end circuitry 54, intermediate-frequency (IF) circuitry 56, and a controller 58. Different antenna systems may share one or more components (e.g., the controller 58 and/or at least a portion of the front-end circuitry 54 and/or at least a portion of the intermediate-frequency circuitry 56). Although the antenna system 50 is shown with only the antenna 52, the antenna system 50 may include more than one of the antenna 52, and each antenna may be electrically coupled to respective front-end circuitry or multiple antennas 52 may be coupled to the same front-end circuitry 54. There may be many different types of antennas collectively used by the devices in the environment 10. The discussion below discusses particular types of antennas that may be used by one or more of the devices in the environment 10, or by other devices in the environment 10 and/or in another environment.

The front-end circuitry 54 may be configured to provide signals to be radiated by the antenna 52 and/or may be configured to receive and process signals that are received by, and provided to, the front-end circuitry from the antenna 52. Alternatively, the front-end circuitry 54 may be configured only to send signals to, or only to receive signals from, the antenna 52. In such instances, different antennas may be used for transmit and receive. For example, antennas discussed below may be used for signal transmission and separate antennas (e.g., dipole antennas) used for signal receipt (e.g., receipt of reflections of signals transmitted from antennas discussed below). The front-end circuitry 54 may be configured to convert received IF signals from the IF circuitry 56 to radio-frequency (RF) signals (amplifying with one or more power amplifiers and/or phase shifting with one or more phase shifters as appropriate), and provide the RF signals to the antenna 52 for radiation. The front-end circuitry 54 may be configured to convert RF signals received by the antenna 52 to IF signals (e.g., using a low-noise amplifier and a mixer) and to send the IF signals to the IF circuitry 56. The IF circuitry 56 may be configured to convert IF signals received from the front-end circuitry 54 to baseband signals and to provide the baseband signals to the controller (processor) 58. The IF circuitry 56 may be configured to convert baseband signals provided by the controller 58 to IF signals, and to provide the IF signals to the front-end circuitry 54.

The controller 58 is communicatively coupled to the IF circuitry 56, which is communicatively coupled to the front-end circuitry 54, which is communicatively coupled to the antenna 52. In some embodiments, transmission signals may be provided from the IF circuitry 56 to the antenna 52 by bypassing the front-end circuitry 54, for example when further upconversion is not required by the front-end circuitry 54. Signals may also be received from the antenna 52 by bypassing the front-end circuitry 54. In other embodiments, a transceiver that is separate from the IF circuitry 56 may be configured to provide transmission signals to and/or receive signals from the antenna 52 without such signals passing through the front-end circuitry 54. In some embodiments, the front-end circuitry 54 may be configured to amplify, filter, and/or route signals from the IF circuitry 56 without upconversion to the antenna 52. Similarly, the front-end circuitry 54 may be configured to amplify, filter, and/or route signals from the antenna 52 without downconversion to the IF circuitry 56.

The controller 58 may be configured to steer an antenna beam of the antenna 52. The controller 58 may include one or more processors and appropriate instructions (e.g., stored on a non-transitory, processor-readable memory) that are configured to cause the processor(s) to perform one or more functions. The one or more functions may include causing signals to be sent to the antenna 52 such that different radiators of the antenna 52 radiate signals with different phases, and with phase differentials that vary over time, to steer a beam produced by the antenna 52. That is, the controller 58 may be configured to cause different phases of the signals to be provided to different radiating elements (e.g., subarrays) of the antenna 52, and different phases of the signals to each of the radiating elements (e.g., subarrays) at different times, to steer a beam produced by the antenna 52 in response to the signals provided by the front-end circuitry 54. The controller 58, in conjunction with the IF circuitry 56 and/or the front-end circuitry 54 as appropriate, comprise controlling means for providing RF signals to the antenna 52 (e.g., signal lines as discussed herein) to steer a beam produced by the antenna 52 (e.g., by transducer stubs as discussed herein).

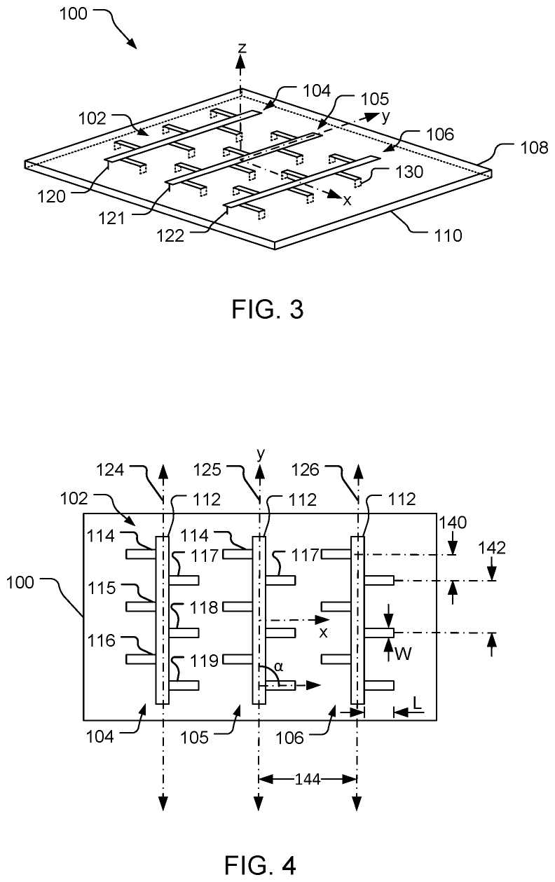

Referring also to FIGS. 3-4, an antenna 100, that is an example of the antenna 52, includes an array 102 that includes subarrays 104, 105, 106 disposed on a substrate 108 that is disposed on a ground plane 110. The substrate 108 may have a dielectric constant greater than one (1) such that wavelengths of signals in the substrate 108 may be shorter than wavelengths of those same signals in free space. The substrate 108 may be disposed in contact with the subarrays 104-106 and the ground plane 110. The substrate 108 may be said to overlie the ground plane 110. The substrate 108 may not be in direct contact with the ground plane 110. For example, an air gap may separate the substrate 108 from the ground plane 110. An effective dielectric constant between the subarrays 104, 105, 106 and the ground plane 110 with the substrate 108 in direct contact with the ground plane 110 may be different than an effective dielectric constant with the substrate separated by an air gap from the ground plane 110. Lengths of transducer stubs (discussed below) may depend on the effective dielectric constant. The ground plane 110 is a ground plane conductor, e.g., made of an electrically-conductive material such as metal (e.g., copper). Here, the antenna 100 includes three subarrays each with six transducer stubs, but other configurations may be used, e.g., with a different quantity of subarrays and/or a different quantity of transducer stubs on each subarray. For example, one or more of the subarrays may include greater than six transducer stubs (e.g., 7, 8, 10, or more). Different quantities of transducer stubs may affect an elevation beam width and/or return loss of the antenna. Further, different subarrays may have different configurations (e.g., different quantities of transducer stubs, different shapes, etc.) in the same antenna. The antenna 100 may be configured for operation in various frequency bands and/or for various uses/applications. For example, the antenna 100 may be configured for millimeter-wave operation as a beam-steered, transmit antenna for an object-detection system for an autonomously-driven vehicle such as the vehicle 28. This is only one example, and the antenna 100 may be configured for use in numerous other systems for numerous other applications. For example, the antenna 100 may be used in any of the base stations 16-19 or other devices in the environment 10.

The subarrays 104-106 each include a signal line 112 each respectively connected to transducer stubs 114, 115, 116, 117, 118, 119 and each connected to a respective one of interface lines 120, 121, 122. Each of the subarrays 104-106 is configured to receive energy of a radiating frequency of the antenna 100 at an input of the subarray 104-106, and/or configured to convey energy of the radiating frequency to an output of the subarray 104-106. For example, the antenna 100 may receive energy where each of the subarrays 104-106 connects to the respective interface line 120-122, with each of the interface lines 120-122 being electrically connected to the front-end circuitry 54. In another example, energy received wirelessly at each of the subarrays 104-106 may be conveyed to the respective interface line 120-122. The signal lines 112 provide a means for delivering RF signals to the transducer stubs 114-119 and/or for receiving RF signals from the transducer stubs 114-119. The substrate 108 is disposed between the signal lines 112 and the ground plane 110 and between the transducer stubs 114-119 and the ground plane 110. The signal lines 112 and the transducer stubs 114-119 are disposed in contact with the substrate 108, here overlying the substrate 108 as shown. The signal lines 112 are electrically-conductive members, here microstrip lines made of metal, that are electrically coupled to the respective input, here the respective interface line 120-122. The interface lines 120-122 connect the signal lines 112 to the front-end circuitry 54 for conveying signals between the signal lines 112 and the front-end circuitry 54 (conveying signals from the signal lines 112 to the front-end circuitry 54 and/or conveying signals from the front-end circuitry 54 to the signal lines 112). The signal lines 112 are connected to the transducer stubs 114-119 and the interface lines 120-122 and configured to convey signals between the transducer stubs 114-119 and the interface lines 120-122. In this example, the signal lines 112 are microstrip lines, but other configurations of signal lines may be used.

Also in this example, the signal lines 112 are connected to the interface lines 120-122 near ends of the signal lines 112. The interface lines 120-122 may be connected to the signal lines 112 at locations other than near ends of the signal lines 112. For example, the interface lines 120-122 may be connected to the signal lines 112 between connection points of transducer stubs to the signal lines 112, e.g., near middles (lengthwise) of the signal lines 112. In such cases, the transducer stubs adjacent to the connection point of the interface line to the signal line 112 may be disposed on, and extend from, the same side of the signal line 112. The signal lines 112 may extend beyond a last transducer stub and terminate in an open circuit. The distances that the signal lines 112 extend beyond the respective last transducer stub may be determined and selected to tune the subarray, e.g., to reduce return loss. In other embodiments, more than one interface line may be coupled to each signal line. For example, one interface line may be coupled near an end of a particular signal line and another interface line may be coupled near the middle. In other examples, multiple interface lines may be coupled in the middle of a signal line, or a respective interface line may be coupled near each end of a particular signal line. The multiple signal lines may be used for different modes, frequencies, for RX/TX, to achieve different transmission/receive characteristics, etc.

The subarrays 104-106 may be disposed along longitudinal axes 124, 125, 126, respectively. In this example, the signal lines 112 are each linear and thus the longitudinal axes 124-126 are centerlines of the signal lines 112, but other (non-linear) configurations of the signal lines 112 may be used. For example, the signal lines 112 may be curved, e.g., S-curved, with transducer stubs extending from concave and/or convex portions of the signal lines. The longitudinal axes 124-126 in this example are substantially parallel (e.g., each pair of the longitudinal axes 124-126 being parallel ±10°) to each other, but other arrangements may be used. Further, in this example, the subarrays 104-106 are aligned lengthwise, i.e., along the axes 124-126, such that the subarrays 104-106 are disposed such that respective first and second ends of the signal lines 112 lie along first and second lines transverse to the longitudinal axes 124-126. In this configuration, each of the stubs 114-119 of adjacent ones of the subarrays 104-106 disposed a similar distance from an end of the respective signal line 112 extends away from the respective signal line 112 in a similar direction. For example, the stubs 114 of the subarrays 104 and 105 both extend in the same direction, to the left in FIG. 4, away from their respective signal lines 112 and the stubs 117 of the subarrays 104 and 105 both extend in the same direction, to the right in FIG. 4, away from their respective signal lines 112. Other configurations, however, may be used. For example, the subarrays may be staggered (offset) such that the subarrays 104-106 are not aligned lengthwise along the axes 124-126 (e.g., every other one of the subarrays are aligned lengthwise, but adjacent subarrays are offset lengthwise).

The transducer stubs 114-119 are configured to transduce signals between electrical signals and wireless signals. A signal that is transduced from electrical to wireless or wireless to electrical is considered to be the same signal and is referred to herein as the same signal. The transducer stubs 114-119 are configured to transduce signals received from the respective signal line 112 into wireless signals and to transduce received wireless signals into electrical signals that the transducer stubs 114-119 provide to the respective signal line 112. The transducer stubs 114-119 are electrically-conductive members (e.g., microstrip stubs made of metal) that are disposed, sized, shaped, and connected (to the signal line 112 and to the ground plane 110) to transduce signals between electrical signals and wireless signals. The transducer stubs 114-119 are illustrated as being relatively consistent in shape, for example as a roughly rectangular shape or linear strip. One or more of the transducer stubs 114-119 of one or more the subarrays 104-106, however, may be shaped differently. For example, one or more of the transducer stubs 114-119 may be curvilinear or diamond shaped.

At least some transducer stubs of a subarray of the array 102 may be disposed on alternating sides of the respective signal line 112. In the example shown, all of the transducer stubs 114-119 are disposed along and on alternating sides of the signal line 112 and all of the subarrays 104-106 have stubs on alternating sides of the signal line 112 (although one or more subarrays may have stubs disposed on one side only of the signal line 112). The stubs 114-119 may be on alternating sides of the signal line 112 with the subarray being connected to an energy coupler line (that connects the antenna 100 to the front-end circuitry 54) at or near an end of the signal line 112. While all of the stubs 114-119 are shown on alternating sides of the signal line 112 for each of the subarrays 104-106, other configurations may be used. For example, if a middle of the signal line 112 is connected to an energy coupler line, then the stubs adjacent to the middle of the signal line 112 may be disposed on the same side of the signal line 112, with the stubs alternating sides of the signal line 112 from the middle of the signal line 112 to respective ends of the signal line 112. Antenna characteristics, such as return loss and/or antenna pattern, may be affected by where the signal line 112 is connected to the energy coupler line.

Centerlines of consecutive transducer stubs are separated by a consecutive stub-to-stub spacing 140, and centerlines of adjacent transducer stubs on the same side of the signal line 112 separated by an adjacent stub-to-stub spacing 142. The consecutive stub-to-stub spacing 140 of at least some of the stubs 114-119 may be about one-half of a wavelength (0.5 λ_{g}±10%) of signals conveyed by the signal line 112 in the substrate 108, and the adjacent stub-to-stub spacing 142 may be about one such wavelength (1.0 λ_{g}±10%). The transducer stubs 114-119 may extend (e.g., have lengths L that are) at an angle α substantially transverse (e.g., 90°±10° (i.e., between 80° and 100°), or 90°±5°) relative to the respective longitudinal axis 124-126. One or more of the transducer stubs 114-119 may extend from the respective longitudinal axis 124-126 by other angles and different transducer stubs may extend from the respective longitudinal axis 124-126 by different angles. For example, stubs may extend from the respective longitudinal axes 124-126 by angles chosen such that the stubs provide one or more desired polarities of radiation/reception of electromagnetic signals.

The transducer stubs 114-119 are shorted stubs, and while traditionally shorted stubs are used as tuning mechanisms, it has been found that shorted quarter-wavelength stubs perform well as transducers as part of the antenna 100. The transducer stubs 114-119 are shorted stubs in that they are shorted to the ground plane 110 by connectors 130. Each of the connectors 130 is electrically-conductive and electrically connects a respective one of the transducer stubs 114-119 to the ground plane 110 approximately one-quarter of a wavelength (0.25 λ_{g}±10%) of signals conveyed by the signal lines 112 and transducer stubs 114-119, in the substrate 108, from the respective signal line 112. That is, each of the connectors 130 is disposed about one-quarter of a wavelength along a length of the respective transducer stub 114-119 from the respective signal line 112. The connectors 130 provide means for shorting each of the transducer stubs 114-119 to ground. The transducer stubs 114-119 may each be about one-quarter wavelength long, with the connector 130 for each of the transducer stubs 114-119 being connected to an end of the respective transducer stub 114-119. With the transducer stubs 114-119 of this length, an azimuth beamwidth (in the x-direction shown in FIG. 3, i.e., transverse to the longitudinal axes 124-126) of about 90° for each subarray 104-106 may be achieved. Each of the connectors 130 may comprise, for example, one or more conductive vias (e.g., one or more plated or filled holes), conductive posts, etc. extending from the respective transducer stub 114-119 through the substrate 108 to the ground plane 110.

Widths W of the transducer stubs 114-119 may be the same, or one or more of the widths W may be different in order to affect a beamwidth in elevation (here, along a y-axis as shown in FIG. 3, which also corresponds to the longitudinal axis 125 in this example) provided by the antenna 100. For example, the widths W of the transducer stubs 114-119 may decrease from the transducer stub 114 to the transducer stub 119. The widths W may be such that an equal amount of power is radiated by each of the transducer stubs 114-119 from a signal provided at the interface line 120-122, i.e., at one end of the signal line 112.

The subarrays 104-106 may be disposed to help provide a desirable antenna pattern for the antenna 100 and/or to facilitate beam steering. For example, the subarrays 104-106 may be disposed side by side as shown. The longitudinal axes 124-126 (here, centerlines of the signal lines 112) of adjacent ones of the subarrays 104-106 may be separated by a distance 144 of about one-half of a free-space wavelength (0.5 λ₀±10%) of signals conveyed by the signal line 112 (i.e., of a radiating frequency of the antenna 100), which may help inhibit grating lobes when a beam of the antenna 100 is steered in azimuth (x-direction shown in FIG. 3).

The subarrays 104-106 are configured to be narrow, i.e., of small dimension transverse to the axes 124-126. The subarrays 104-106 are configured and disposed such that the transducer stubs 114-119 of adjacent subarrays do not overlap along lengths of the transducer stubs 114-119 (in the x-direction in the example shown in FIGS. 3-4), which may help inhibit coupling (help provide good isolation) between subarrays and thus help maintain good performance (low return loss (S₁₁)). With the longitudinal axes 124-126 separated by about one-half of a free-space wavelength (0.5λ₀±10%) of signals conveyed by the signal lines 112, the signal lines 112 having widths of about 5% of a wavelength of the signals, in the substrate 108, conveyed by the signal lines 112, and lengths L of the transducer stubs being about one-quarter of a wavelength (0.25 λ_{g}±10%) of signals, in the substrate 108, conveyed by the signal lines 112, and the dielectric constant of the substrate 108 being greater than 1.0, the transducer stubs 114-119 of adjacent subarrays will not overlap lengthwise. For example, with the dielectric constant being about 3.4, the transducer stubs 114-119 of adjacent subarrays may be separated transverse to the longitudinal axes 124-126 by about one-fifth of a wavelength (0.2 λ_{g}±10%) of signals, in the substrate 108, conveyed by the signal lines 112.

Operation

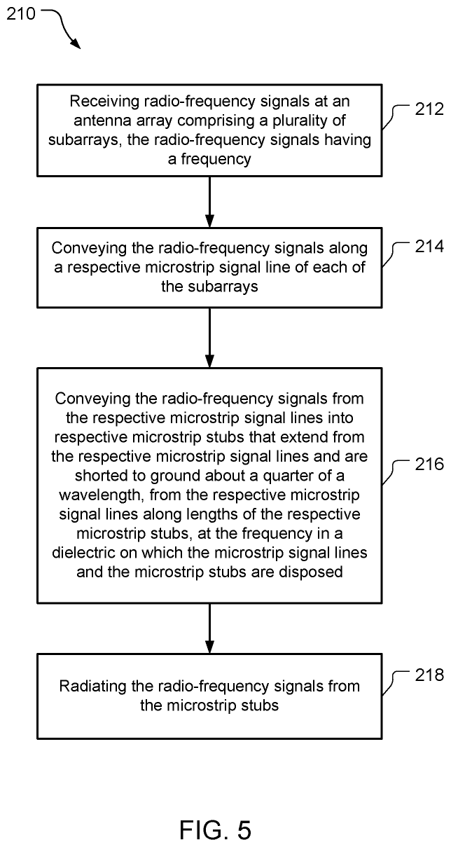

Referring to FIG. 5, with further reference to FIGS. 1-4, a method 210 of operating an antenna system (e.g., the antenna system 50) includes the stages shown. The method 210 is, however, an example only and not limiting. The method 210 may be altered, e.g., by having stages added, removed, rearranged, combined, performed concurrently, and/or having single stages split into multiple stages. Still other alterations to the method 210 as shown and described may be possible.

At stage 212, the method 210 includes receiving radio-frequency signals at an antenna array comprising a plurality of subarrays, the radio-frequency signals having a frequency. The controller 58 may send signals to the IF circuitry 56, that converts the signals from baseband to an intermediate frequency and provides the IF signals to the front-end circuitry 54. The front-end circuitry converts, as appropriate, the IF signals from the IF circuitry 56 to RF signals and provides the RF signals to the antenna 52, for example the antenna 100 with subarrays such as the subarrays 104-106.

At stage 214, the method 210 includes conveying the radio-frequency signals along a respective microstrip signal line of each of the subarrays. For example, the RF signals are provided to the signal lines 112 via the interface lines 120-122 and propagated along the signal lines 112 of the subarrays 104-106. The propagated signals may induce standing waves in the signal lines 112.

At stage 216, the method 210 includes conveying the radio-frequency signals from the respective microstrip signal lines into respective microstrip stubs that extend from the respective microstrip signal lines and are shorted to ground about a quarter of a wavelength, from the respective microstrip signal lines along lengths of the respective microstrip stubs, at the frequency in a dielectric on which the microstrip signal lines and the microstrip stubs are disposed. The RF signals propagated along the signal lines 112 may propagate into the transducer stubs 114-119 that are shorted to the ground plane 110 by the connectors 130 about a quarter of a wavelength, in the substrate 108 (i.e., considering the dielectric constant of the substrate 108). The amount of the signals propagated into the respective transducer stubs 114-119 may depend on various factors such as location of the stubs 114-119 along the signal line 112 (e.g., relative to a standing wave in the signal line and/or relative to where the respective interface line 120-122 connects to the signal line 112).

At stage 218, the method 210 includes radiating the radio-frequency signals from the microstrip stubs. For example, the transducer stubs 114-119 may transduce the signals received by the transducer stubs 114-119 into wireless signals that are radiated from the antenna 100. At least some of the transduced signals (i.e., at least some of the energy in the transduced signals) is propagated away from the antenna 100. Energy from each the subarrays 104-106 combine to form a beam directed relative to the antenna 100 based on relative phase of the energy in the transducer stubs 114-119 in the respective subarrays 104-106.

The method 210 may be modified, e.g., to include one or more further features. For example, the method 210 may further include sending the radio-frequency signals to the antenna array, with the microstrip signal lines being disposed parallel to each other with adjacent ones of the microstrip signal lines having respective centerlines separated by about one half of a free-space wavelength at the frequency, to steer a beam provided by radiating the radio-frequency signals from the microstrip stubs. The controller 58 can send signals, including control signals as appropriate, to the IF circuitry 56 and the front-end circuitry 54 such that the RF signals provided to the antenna 52, e.g., the antenna 100, have different phases for different radiating elements (e.g., the transducer stubs 114-119 of different subarrays 104-106) and to change the phase differences over time to steer the beam provided by the antenna 100 (i.e., change a direction of a main beam provided by the antenna 100). For example, the controller 58 may cause the beam to sweep in azimuth side to side. This may be useful, for example, in an application of an object-detection system of a vehicle to be able to identify the presence of an object and a location of the object relative to the vehicle.

Other modifications of the method 210 may include transducing wireless signals at a plurality of microstrip stubs into radio-frequency electrical signals. For example, the microstrip stubs (e.g., the transducer stubs 114-119) may each be connected to a signal line (e.g., the signal line 112) and shorted to a ground plane (e.g., the ground plane 110). In some embodiments, the microstrip stubs are each about a quarter of a wavelength, from the microstrip signal line along the length of the microstrip stub to the short, at the frequency of the signals in a dielectric on which the microstrip signal line and the microstrip stubs are disposed. The method may further include conveying the RF electrical signals from the microstrip stubs into the microstrip signal line, and conveying the RF signals along the microstrip signal line. The method may further include transmitting the RF signals to circuitry within a device in which the microstrip stubs and the microstrip line are disposed for processing. The microstrip stubs and microstrip line may be disposed in a first subarray of a plurality of similarly configured subarrays, and the transducing and conveying may be performed at the plurality of subarrays. In some embodiments, the RF signals from each subarray are shifted by a respective phase amount prior to being transmitted to the circuitry for processing.

Example Applications

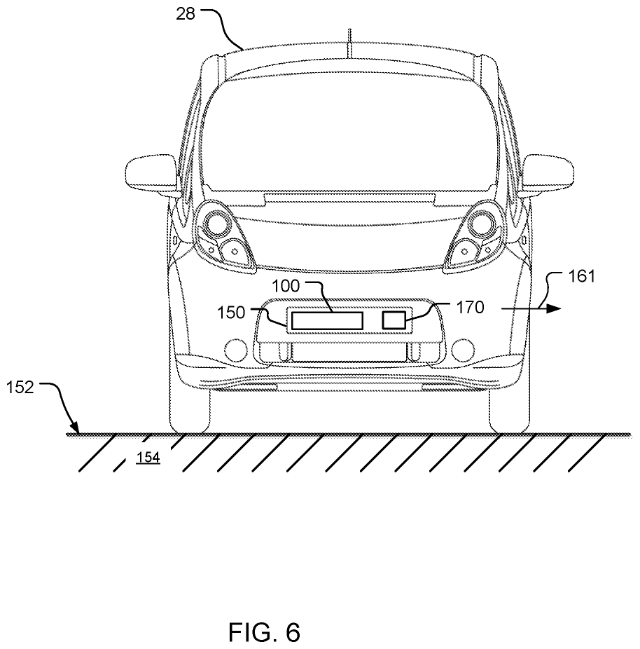

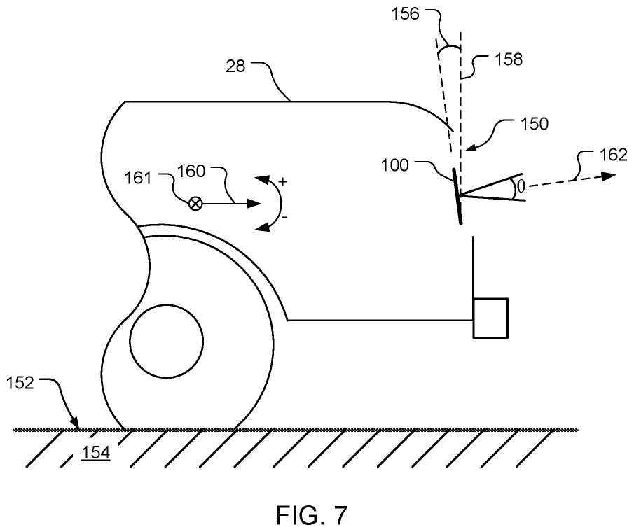

Referring to FIGS. 6-7, with further reference to FIGS. 1-4, an example application for the antenna 100 is in the vehicle 28 shown in FIG. 1 as part of an object-detection sub-system that is part of an autonomous-driving system. As shown in FIG. 6, the antenna 100 may be disposed at a front end of the vehicle 28, here in a grill area of the vehicle 28. Alternatively, the antenna 100 may be located elsewhere on/in the vehicle 28, e.g., at a rear of the vehicle 28, in a bumper of the vehicle 28, etc. An aperture 150 may be provided by the vehicle 28 in a field of view of the antenna 100 to help avoid interference by the vehicle 28 with signals transmitted by or received by the antenna 100. For this application, an example of the antenna 100 may include 128 subarrays each having the signal line 112 connected on one end to a respective interface line, and each having six (6) transducer stubs alternating sides of the respective signal line 112 as shown in FIGS. 3-4. With this configuration, the antenna 100 may provide an elevation (in the y-z plane shown in FIG. 3) beamwidth θ of about 25°. As shown in FIG. 7, the antenna 100 may be tilted at an angle 156 relative to an elevation axis 158 transverse to a first azimuthal axis 160 of the vehicle 28, where the vehicle 28 is configured to have the axis 160 be substantially parallel (e.g., parallel+/−10°) to a surface 152 of the earth 154 (at the location of the vehicle 28). For example, the antenna 100 may be tilted such that a boresight 162 thereof is about 7.5° away from the axis 160 and the surface 152 of the earth 154 (i.e., the ground) so that the beamwidth θ is directed from about 5° toward the earth 154 to about 20° away from the earth 154 (about −5° from the axis 160 (downward as shown) to about +20° from the axis 160 (upward as shown)). This would help with detection of obstacles at ground level while helping to avoid detection of obstacles located skyward relative to the vehicle 28. The antenna 100 may be angled such that the beamwidth θ is directed at least partially toward the earth. For example, in the configuration described above in which the beamwidth θ is about 25°, the antenna 100 (and thus one or more of the subarrays including the signal lines 112 and transducer stubs thereof) may be angled approximately 12° or less with respect to the axis 158 transverse to the axis 160 (that is, the angle 156 may be approximately 12° (e.g., 12°+/−10%) or less). Thus, lengths of the signal lines 112 may be disposed at the angle 156. An azimuthal plane of the vehicle 28 may defined by the first azimuthal axis 160 and a second azimuthal axis 161 (see also FIG. 6) that is transverse to the axis 160, with the vehicle 28 being configured to have the axis 161 be substantially parallel (e.g., parallel+/−10°) to the surface 152 of the earth 154 (at the location of the vehicle 28). The antenna 100 may be disposed in the vehicle 28 such that the signal lines 112, which comprise components of means for delivering RF signals to transducer stubs, are spaced apart in the azimuthal plane of the vehicle 28. The antenna 100 may be used for transmitting signals and a separate antenna 170 (e.g., a dipole antenna including a dipole array) used for receiving reflections of the signals transmitted by the antenna 100. In this case, the antenna 100 is a transmit array and the separate antenna 170 is a receive array configured to receive reflected signals, i.e., reflections of signals transmitted by the transmit array. The antenna 170 may be communicatively coupled to the front-end circuitry 54 and configured to provide the reflected signals to the front-end circuitry 54. The signals provided to the front-end circuitry 54 by the antenna 170 are transduced signals of the wireless reflected signals, but are referred to as the reflected signals for simplicity. The example of the antenna 100 with 128 subarrays may have a size of about 15 mm by 240 mm for operation over a range of 76 GHz to 81 GHz. At this frequency range, with 128 subarrays as described, beam steering with 1° may be achieved.

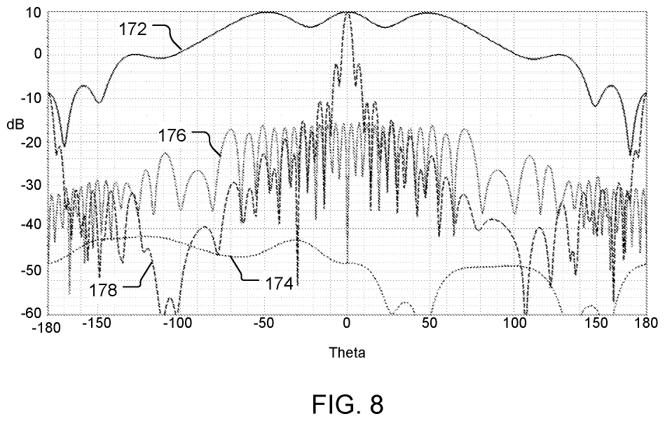

As another example, simulations were performed for a single subarray with 36 transducer stubs. Simulations for this example subarray showed a return loss of less than −9.5 dB over a frequency range of 76 GHz to 81 GHz, gain greater than 10 dBi, and bandwidth greater than 120°. For example, referring to FIG. 8, simulations of this example subarray yielded an azimuth co-pol plot 172, an azimuth cross-pol plot 174, an elevation co-pol plot 176, and an elevation cross-pol plot 178.

Other Considerations

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, an indication that a device is configured to perform a stated function means that the device contains appropriate equipment (e.g., circuitry, mechanical device(s), hardware, software (e.g., processor-readable instructions), firmware, etc.) to perform the stated function. That is, the device contains equipment that is capable of performing the stated function, e.g., with the device itself having been designed and made to perform the function, or having been manufactured such that the device includes equipment that was designed and made to perform the function. An indication that processor-readable instructions are configured to cause a processor to perform functions means that the processor-readable instructions contain instructions that when executed by a processor (after compiling as appropriate) will result in the functions being performed.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, a wireless communication device may communicate through one or more wired connections as well as through one or more wireless connections.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium,” “processor-readable medium,” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

1. An antenna system comprising:
a ground plane conductor;
a substrate disposed in contact with the ground plane conductor; and
an array comprising a plurality of subarrays each configured to receive energy of a radiating frequency at an input of the subarray and each comprising:
a microstrip signal line electrically coupled to the input and disposed in contact with the substrate such that the substrate is disposed between the microstrip signal line and the ground plane conductor;
a plurality of microstrip stubs extending from the microstrip signal line and disposed in contact with the substrate such that the substrate is disposed between the plurality of microstrip stubs and the ground plane conductor; and
a plurality of electrically-conductive connectors each connected to a respective one of the plurality of microstrip stubs about one-quarter of a wavelength, at the radiating frequency in the substrate, from the microstrip signal line along a length of the respective one of the plurality of microstrip stubs and electrically connecting the respective one of the plurality of microstrip stubs to the ground plane conductor.

2. The antenna system of claim 1, wherein the microstrip signal lines of adjacent pairs of the plurality of subarrays have centerlines disposed substantially parallel to each other and separated by about one-half of a free-space wavelength at the radiating frequency.

3. The antenna system of claim 1, wherein each of the plurality of electrically-conductive connectors comprises at least one conductive via extending from a respective one of the plurality of microstrip stubs through the substrate to the ground plane conductor.

4. The antenna system of claim 1, further comprising:
front-end circuitry electrically coupled to the input of each of the plurality of subarrays and configured to provide signals to the plurality of subarrays; and
a controller communicatively coupled to the front-end circuitry and configured to cause the front-end circuitry to provide different phases of the signals to different ones of the plurality of subarrays to steer a beam produced by the array in response to the signals provided by the front-end circuitry.

5. The antenna system of claim 4, wherein the array is a transmit array, the antenna system further comprising a receive array configured to receive reflected signals comprising reflections of signals transmitted by the transmit array, the receive array being communicatively coupled to the front-end circuitry and configured to provide the reflected signals to the front-end circuitry.

6. The antenna system of claim 1, wherein for each of the plurality of subarrays, at least some of the plurality of microstrip stubs extend from the microstrip signal line on alternating sides of a centerline of the microstrip signal line.

7. The antenna system of claim 6, wherein the at least some of the plurality of microstrip stubs have center-to-center spacings of about one-half of the wavelength at the radiating frequency in the substrate.

8. The antenna system of claim 6, wherein each stub of adjacent subarrays disposed a similar distance from an end of the respective microstrip signal line extends away from the respective microstrip signal line in a similar direction.

9. The antenna system of claim 1, wherein each of the plurality of microstrip stubs extends from the microstrip signal line at an angle between 80° and 100° relative to a longitudinal axis of the microstrip signal line.

10. The antenna system of claim 1, wherein different ones of the plurality of microstrip stubs have different widths.

11. A method of operating an antenna system, the method comprising:
receiving radio-frequency signals at an antenna array comprising a plurality of subarrays, the radio-frequency signals having a frequency;
conveying the radio-frequency signals along a respective microstrip signal line of each of the plurality of subarrays;
conveying the radio-frequency signals from the respective microstrip signal lines into respective microstrip stubs that extend from the respective microstrip signal lines and are shorted to ground about a quarter of a wavelength, from the respective microstrip signal lines along lengths of the respective microstrip stubs, at the frequency in a substrate on which the microstrip signal lines and the microstrip stubs are disposed; and
radiating the radio-frequency signals from the microstrip stubs.

12. The method of claim 11, further comprising sending the radio-frequency signals to the antenna array, with the microstrip signal lines being disposed parallel to each other with adjacent ones of the microstrip signal lines having respective centerlines separated by about one half of a free-space wavelength at the frequency, to steer a beam provided by radiating the radio-frequency signals from the microstrip stubs.

13. An antenna system comprising:
one or more subarrays each comprising a plurality of transducer stubs;
means for delivering radio-frequency signals to the plurality of transducer stubs along a length of a respective portion of the means for delivering in each of the plurality of subarrays; and
means for shorting each of the plurality of transducer stubs, to a ground of the antenna system, about one-quarter of a wavelength of a frequency of the radio-frequency signals along a length of each of the plurality of transducer stubs.

14. The antenna system of claim 13, wherein the respective portions of the means for delivering are arranged in the array with a center-to-center spacing of about one-half of a free-space wavelength of the frequency of the radio-frequency signals.

15. The antenna system of claim 14, further comprising controlling means for providing the radio-frequency signals to the means for delivering to steer a beam produced by the plurality of transducer stubs.

16. The antenna system of claim 13, wherein each of the one or more subarrays comprises at least six transducer stubs.

17. The antenna system of claim 13, wherein the one or more subarrays comprises a plurality of subarrays disposed in an apparatus such that conductive lines of the means for delivering are spaced apart in an azimuthal plane of the apparatus.

18. The antenna system of claim 17, each of the conductive lines of the means for delivering is angled with respect to an elevation axis of the apparatus by approximately twelve degrees or less.

19. The antenna system of claim 18, wherein the apparatus comprises a car.

20. The antenna system of claim 13, wherein the antenna system comprises a portion of a base station configured to communicate using millimeter-wave signals.
